(19) United States
(12) Patent Application Publication
(10) Pub. No.: US 2008/0036810 A1
(43) Pub. Date: Feb. 14, 2008

(54) Printing Processes Such as for Uniform Deposition of Materials and Surface Roughness Control

(76) Inventors: Michael J. Dixon, Richmond, KY (US); Paul J. Sacoto, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/427,460

(22) Filed: Jun. 29, 2006

(51) Int. Cl. B41J 2/205

(52) U.S. Cl. 347/15

(57) ABSTRACT

A fluid printing process such as one that includes subdividing a desired printed pattern into geometrical elements and thereafter sequentially printing these elements in a series of subsets by depositing one or more fluid formulations onto a substrate, and subsequently exposing the deposited fluids to energy in order to dry the deposited one or more fluids substantially and immediately upon deposition so as to control at least one of solid deposition and surface roughness.

### BACKGROUND OF THE INVENTION

1. Field of the Invention

The present invention relates generally to fluid printing processes, and specifically, in an exemplary embodiment, to a printing process of subdividing a pattern into subsets of geometrical elements and thereafter printing and rapidly curing the subsets to achieve a composite of the pattern which exhibits a uniform distribution of material.

2. Background of the Invention

Inkjet printing is evolving into new fields and being used in nontraditional ways to print devices and structures varying from printable electronics to pharmaceuticals and biomimetic structures. These emerging technologies utilize a wide variety of different materials in jettable solutions and apply them to a wide variety of substrates ranging from paper and micropores photo media to FR4 circuit, boards, glass and/or polymers films. Jettability requirements dictate that these solutions possess certain rheological properties. In order to obtain these required rheological properties, jettable fluid formulations often contain various components including, but not limited to, surfactants and humectants. By way of example, aqueous based fluid formulations operable for use with thermal inkjet printers typically include humectants i.e., co-solvents with higher boiling points than water introduced to prevent drying of the ink in the nozzles of the print head during periods of printing inactivity.

In conventional printing processes, once the solution or suspension has been jetted onto a substrate, water and co-solvent removal is accomplished either through evaporation and/or absorption by the substrate. In traditional applications of inkjet such as printing onto uncoated paper or microporous photo media, absorption has been the dominant mechanism for water and solvent removal as the timescale for absorption is typically much faster than evaporation. In cases where the absorptive capacity of the substrate is low, as is the case with smooth non porous substrates like FR4 circuit boards, glass, or polyimide films, the solvent and water removal has been accomplished by evaporation. Typically, evaporation takes much longer than absorption especially when humectant additives are included in the formulation or when environmental factors such as temperature and relative humidity vary. Disadvantageously, because of the longer timescale for evaporation versus absorption, there is time for the solute materials to migrate in the solvent once on the substrate. Typically, fluid is digitally deposited on the substrate according to a two-dimensional layout pattern where adjacent fluid drops are touching and may flow together to form a larger pool/puddle within which the solute materials can then migrate. Therefore, draining away the solvent by absorption provides a more uniform deposition of solute molecules on the substrate.

The migration of solute materials can manifest in undesired non-uniformities in the resulting solid material deposition pattern on the substrate. In some instances, this manifestation can be quite dramatic. One example which can be observed is the “coffee ring effect.” It will be understood by those skilled in the art that the coffee ring effect refers to an instance where solids are concentrated at the periphery of a drying shape during evaporation. In traditional cases having the coffee ring effect, the mechanism appears consistent with capillary driven flow of solvents from the center of the fluid element to its edges. The fluid element loses solvent by evaporation more or less uniformly over its surface area and the surface level drops. If the edges of the fluid element are pinned, then the volume element bounded by equal, surface area and the original and final surface positions of the fluid element will be larger near the center of the fluid element than near the edge. This requires that solvent, flow from the center to the edge to replenish the lost volume. This solvent carries with it more solute material, and the coffee ring continues to develop over the course of evaporation.

In the case of Inkjet formulations, the presence of various surfactants either in the formulation or on the surface of the substrate further complicates the control, of solid deposition. For example, Marangoni type flow patterns driven by surface tension gradients from the center to the edge of a drop may result. It will he understood by those skilled in the art that the “Marangoni effect” is a mass transfer on, or in, a liquid layer due to spatial surface tension differences. More particularly, since a liquid with high surface tension pulls more strongly on its surface than one with a low surface tension, the presence of a gradient in surface tension will naturally cause the liquid to flow away from regions of low surface tension.

The aforementioned coffee ring effect is an undesirable phenomenon that can be detrimental to the function of the resulting solid film. By way of example, the coffee ring effect is particularly undesirable in the field of printed dielectric film for multilayer printed electronic applications. In such applications, it is important that the film be uniform in thickness and has no thin spots where dielectric breakdown can occur between conductive layers above and below the dielectric layer. A certain minimum thickness is required to achieve the desired dielectric strength and breakdown voltage for a given application. It may be necessary to overprint several successive layers of material to achieve this thickness. If, with successive layers of printed geometry most of the material migrates to the periphery of the printed shape, then more printing layers will be required to achieve the necessary thickness. This results in a wasting of materials, an increase in production costs and an increase in the complexity to the manufacturing process. Also, if the cross-sectional profile of the resulting film, has a high ridge/berm at its edge, uniform coverage of subsequent layers can be problematic. Topographical extremes, such as ridges and berms, present a major challenge for uniform coverage of subsequent layers and can lead to such issues as thin spots in dielectric or protective overcoats, or poor step coverage of conductive traces. A conductive trace in a second conductive layer printed over a dielectric may thin or break as it goes over this high spot to make contact with the underlying first conductive layer either in a via or at the edge of the patterned dielectric.

In order to address the foregoing, there have been many attempts to control the coffee ring effect through various formulations. Various co-solvents have been added and different surfactants have been used. Prior art teaches that surfactants and temperature gradients may be used to cause Marangoni flows to reverse the coffee ring effect such that solids concentrate at the center of a drop rather than at the periphery. Surfactants may also be used to cause Marangoni-Bernard convective flows to deposit solids in hexagonal shapes. Formulation changes are limited, however, to the rheological operating window that is required to maintain jetting performance, ink shelf life, and chemical stability. This often entails a trade off in the chemical, physical or electrical properties of the resulting film.

Referring now to FIG. 1, a sectional diagrammatic view of the driven fluid flow from center to the periphery in a pinned drop during evaporation is illustrated, i.e., coffee ring effect. As shown, areas A and B illustrate a cross section of a drop during an infinitesimal, increment of evaporation. Area 10 represents the volume of solvent removed from the drop by evaporation in a specific increment of time. This solvent removed from the edge is replaced by more solvent flowing outward from the center, shown as 12. Referring now to FIG. 2, an exemplary coffee ring effect at the edge of a printed shape is illustrated in a cross-sectional view. As illustrated, two berms 14a and 14b at the edge of the cross-section are separated by a relatively Sower level or plateau 16. In order to avoid the onset of the coffee ring effect, the inventors determined it is desirable to reduce the width of the printed pattern such that the berms 14a and 14b are closed together and the plateau 16 narrows. At a critical width, the two berms 14a and 14b merge together, thereby forming a single berm 18 and eliminating the coffee ring effect.

### SUMMARY OF THE INVENTION

In view of the shortcomings of the current processes, systems and methods of printing and drying fluid formulations upon a substrate, a need exists for new processes, systems and methods for printing fluid formulations upon a substrate so as to control the migration of materials in drying fluid elements including capillary driving flow of solvents from the center of a drop to the periphery thereof (i.e., the coffee ring effect), without requiring formulation changes, but rather through a change in the printing process. Exemplary processes, systems and methods of this invention require the subdivision of a desired printed pattern into two or more subsets with the appropriate geometry and sequentially printing and rapidly curing these subsets such that a controlled profile with a more uniform material deposition is produced. In addition, these processes, systems and methods allow subset geometries to be modified to provide a tunable surface roughness. Desirable systems would include an on-carrier drying device which is operable for rapidly drying/curing deposited fluid formulations on the substrate. These desirable systems would include control modules for determining geometric subdivision of the pattern and component operation.

Among various embodiments, the present invention provides an ink jet printing process which eliminates non uniform materials deposition due to undesirable fluid flow including the coffee ring effect currently found in printed objects independent of fluid formulations. In various exemplary embodiments, the present invention provides an ink jet printing process that includes subdividing a desired printed pattern into geometrical elements and thereafter sequentially printing these elements in a series of subsets by depositing one or more fluid formulations onto a substrate, and subsequently exposing the deposited fluids to heat energy in order to dry the deposited one or more fluids substantially and immediately upon deposition so as to control solid deposition and surface roughness. While the exemplary embodiments generally describe an ink jet printing process, the system and methods of the present invention may be applied to any printing processes.

One exemplary embodiment of the present invention is directed to an ink jet printing process which comprises subdividing a desired printed pattern (e.g., an image) into geometric elements forming two (or more) subsets and sequentially printing and drying the subsets so as to control solid deposition and surface roughness. The sequential printing and drying of the geometric elements of the subsets is performed by depositing fluid droplets upon a substrate which form a subset of a desired pattern and curing the droplets prior to the deposition of the remaining subsets. An exemplary embodiment of the present invention is also directed to Inkjet printing processes using fluid formulations that are deposited on a substrate in the form of geometric elements of a predetermined subset and thereafter exposed to heat energy from an on-carrier drying device to rapidly dry the ink prior to the deposition of fluid formulations of another subset, the sum of the subsets forming a composite pattern.

Additional features and advantages of exemplary embodiments of the invention are set forth in the detailed description which follows and will be readily apparent to those skilled in the art from that description, or will be readily recognized by practicing the invention as described in the detailed description, including the claims, and the appended drawings. It is also to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof. Additionally, the drawings and descriptions are meant to be merely illustrative and not limiting the intended scope of the claims in any manner.

### BRIEF DESCRIPTION OF THE DRAWINGS

FIG. 1 is a diagrammatic view of a conventional driven fluid flow from center to the periphery of a pinned drop during evaporation;

FIG. 2 cross-sectional view of a decreasing critical width of a droplet below which no coffee ring effect is present;

FIG. 3 is a plan view of a layout contact profilometry of an acrylate based fluid formulation on an ink receiving layer on FR4 circuit board material constructed in accordance with an exemplary embodiment of the present invention;

FIG. 4 is a graph illustrating contact profilometry results for the layout of FIG. 3;

FIG. 5 is a schematic view of two subsets having predetermined geometric shapes being overprinted to form a composite pattern constructed in accordance with an exemplary embodiment of the present invention;

FIG. 6 is a schematic diagram of an exemplary printing apparatus for use in sequentially printing and drying the subsets of geometric elements;

FIG. 7 is a schematic diagram of an exemplary configuration of an on-carrier drying system;

FIG. 8 is a schematic diagram of an exemplary drying device including an infrared emitter;

FIG. 9 is a graph illustrating a profile of a 1 cm acrylate square printed in 8 solid overlapping layers demonstrating the existing of the coffee ring effect;

FIG. 10 is a graph illustrating a profile of a 1 cm acrylate square with 8 composite layers overlaid on the profile of FIG. 8;

FIG. 11 is a graph illustrating a profile of a 1 cm acrylate square printed in 8 solid overlapping layers demonstrating the existing of the coffee ring effect and viewed from the horizontal direction;

FIG. 12 is a graph illustrating a profile in both directions of a 1 cm acrylate square printed using alternative horizontal and vertical composite layers;

FIG. 13 is a graph illustrating surface profiles of a 1 cm square composed of subsets comprising parallel 0.5 mm and 0.2 mm lines;

FIG. 14 is a graph illustrating roughness as a function of bar element width; and

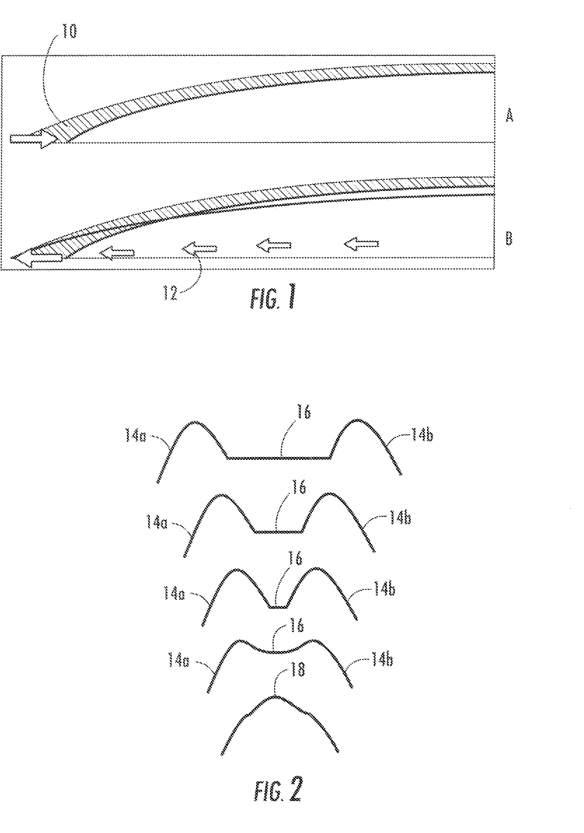

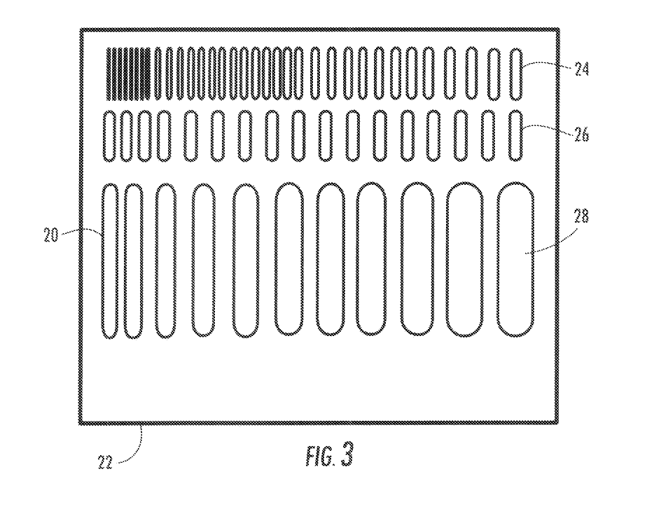

### DETAILED DESCRIPTION OF THE EXEMPLARY EMBODIMENTS

Reference will now be made in detail to exemplary embodiments of the invention, which are illustrated in the accompanying drawings. Whenever possible, the same reference numerals will be used throughout the drawings to refer to the same or like parts. Further, as used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The present invention, in one embodiment, provides an ink jet printing process for printing and drying a desired pattern upon a substrate in a sequential manner by depositing droplets of a fluid formulation (sometimes referred to by example hereinafter as an “ink” formulation), such that the droplets deposited form subsets of geometric elements, the composite of which forms the desired pattern. In the exemplary embodiments, the deposited droplets are cured/dried upon the substrate substantially immediately after printing so as to provide an improved, uniform distribution of materials. In exemplary embodiments described herein, the droplets of the ink formulation are printed and dried using an ink jet printer having an on-carrier drying device capable of emitting predetermined electromagnetic wavelengths, such as infrared, ultra-violet, radio frequency, or microwave. The drying/curing step and the drying device are employed in the printing process and system for the purpose of rapidly drying the deposited ink formulation onto the substrate so that the aforementioned disadvantages of non-uniform materials deposition due to an undesirable fluid flow (the “coffee ring effect”) are overcome and when additional droplets are deposited, they do not bleed together. By using the exemplary printing processes, a composite pattern may be produced which exhibits a more uniform distribution of materials than the original material shape would have if it was not subdivided. Further, by using the exemplary printing processes, a composite shape which exhibits a desired roughness profile to promote adhesion of subsequently overlaid layers may be produced. Still further, by using the exemplary printing processes, de-wetting/beading up of deposited ink formulations on smooth low energy surfaces may be prevented.

As used throughout this description, the term “substrate” is intended to mean any material having a surface operable for receiving a fluid composition from a printing device. Further, it will be understood by those skilled in the art that the substrate may be any now known or hereafter devised recording media used in printing systems, including, but not limited to, commercially available paper, specialty papers, envelopes, transparencies, labels, card stock, micro-porous photo media, FR4 circuit boards, glass, polymer films and the like.

The exemplary embodiments provide an ink jet printing method and process which generally comprises subdividing a desired printed pattern (e.g., an image) into geometric elements forming two (or more) subsets and sequentially printing and drying the subsets so as to control material deposition and surface roughness. The sequential printing and drying is generally performed by: (a) heating the fluid in an image wise pattern of one of the subsets to cause bubbles to form therein, thereby causing droplets of the formulation to be ejected in the subset pattern onto a substrate; (b) exposing the ejected droplets on the substrate to heat energy, thereby rapidly drying/curing the fluid formulation on the substrate; (c) heating an additional fluid formulation in an image wise pattern of another of the subsets to cause bubbles to form therein, thereby causing droplets of the formulation to be ejected in the another subset pattern onto a substrate; and (d) exposing the ejected droplets on the substrate to heat energy, thereby rapidly drying the fluid on the substrate and forming the completed, desired pattern. It will be understood by those skilled in the art that the foregoing description of sequentially printing and drying the subsets of geometric elements to form a composite pattern is directed to a pattern that has been subdivided into two distinct subsets. It is foreseeable that other patterns may require additional subsets to provide a higher print quality. Thus, the printing and drying steps may be repeated as necessary.

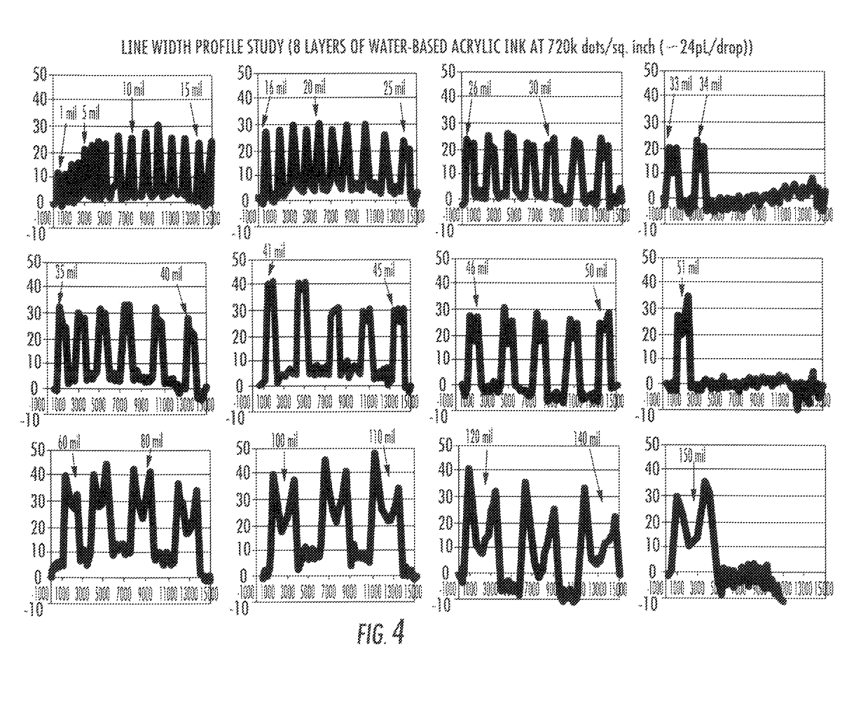

In the exemplary embodiments, the geometric elements are dimensioned such that none are larger than the size at which the coffee ring effect onsets. It will be understood by those skilled in the art that the dimension (or width) just below which the coffee ring effect onsets is known as the “critical width.” By way of example, it has been found that for thermally ink jettable materials the critical width is typically on the order of ½ mm (500 um). The critical widths of the geometric elements are dependant upon various properties such as ink formulations/solids content, viscosity, surface tension and the properties of the substrate material. One method of determining the critical width of the geometric elements is through the use of contact profilometry. For exemplary purposes and referring to FIGS. 3-4, contact profilometry has been used to characterize as a plurality of printed lines 20 of an acrylate based ink formulation with different drawn widths on an ink receiving layer on FR4 circuit board material 22. The layout and corresponding profilometry results are shown in FIG. 3-4 respectively. As best shown in FIG. 3, the plurality of lines 20 in the first two rows, 24 and 26, range in width from 1 mil (25 um) to 51 mil (1.275 mm) in 1 mil increments. The final row 28 of lines 20 ranges from 60 mil to 150 mil in 10 mil increments. The profilometry results (FIG. 4) demonstrate the maximum width below which no coffee ring is present. For this particular ink and substrate combination and printing conditions, the onset of the coffee ring effect can be observed at approximately 25 mil drawn width.

In exemplary embodiments, the geometric elements are deposited such that they are substantially disconnected in order to ensure that no undesirable fluid flow can exist between neighboring elements within a single subset prior to the drying/curing cycle. The geometric elements may also be macroscopic (larger than 1-2 single droplets) in nature. Thus, in order to subdivide a pattern into two or more subsets comprising geometric elements having no substantial connections between elements of one subset or overlap of elements and another, it is necessary to use subset geometries which can be exactly interlocked or tessellated to exactly cover the same area as the original pattern. This cannot be accomplished at the single droplet level because droplets are in the form of circles. Accordingly, various shapes, other than circles, may be used, including, but not limited to, squares, triangles, pentagons, parallel bars etc. Additionally, various arrangements of geometric elements may be used such as checkerboard type arrangements of squares or rectangles. In an exemplary embodiment, the geometric subdivision may be performed using the printer driver or through the use of software such that user interaction is limited and/or eliminated.

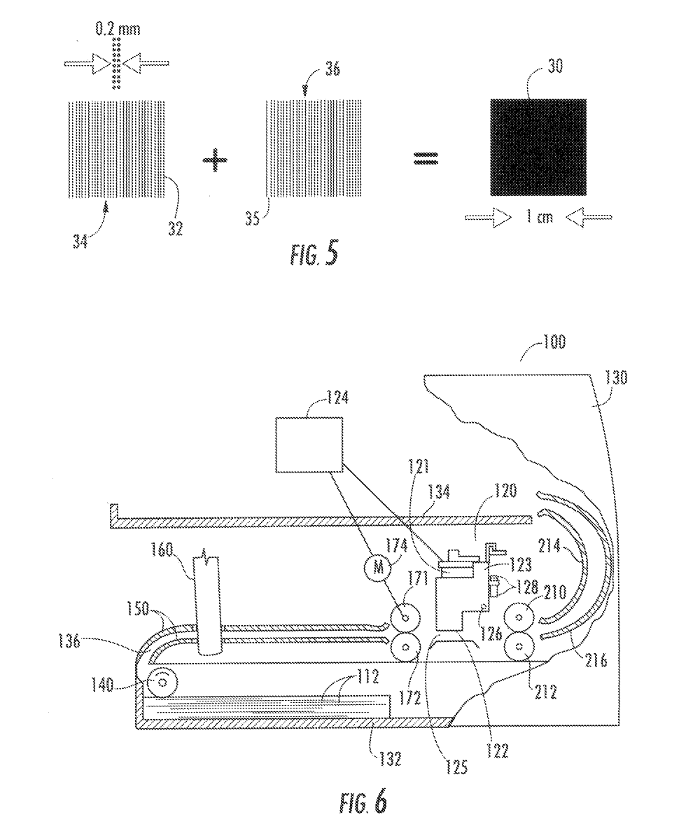

Referring now to FIG. 5, an exemplary printing process is demonstrated. As shown, a composite 1 cm square image 30 has been subdivided into 50 geometric elements 32, parallel lines or rectangles, each having a width of 0.2 mm, wherein no geometrical element exceeds the critical width for coffee ring formulation. The 50 parallel lines 32 of the square 30 have been further separated into two distinct subsets 34 and 36. Each of the two subsets 34, 36 comprises 25 0.2 mm lines/rectangles separated by 0.2 mm spaces 35. By sequentially overprinting and curing the subsets 34, 36, the lines in the second subset 36 are aligned with the spaces in the first subset 34. Accordingly, the two complementary subsets 34, 36 form the original 1 cm square 30.

Between printing each subset 34, 36 of geometric elements 32 are locked-in the “coffee ringless” pattern by drying/curing the newly deposited ink formulation or overprinting some other chemical formulation or both. Otherwise, the uncured material on the substrate will flow together with newly printed material. In exemplary embodiments, the curing/drying of the deposited ink formulation may be accomplished by using an on-carrier drying device in the printer. The use of such an on-carrier drying device obviates the need to complete the printing of the first subset 34 before beginning priming of the second subset 36. This results in a decrease in the overall print time and an increase in printing efficiency.

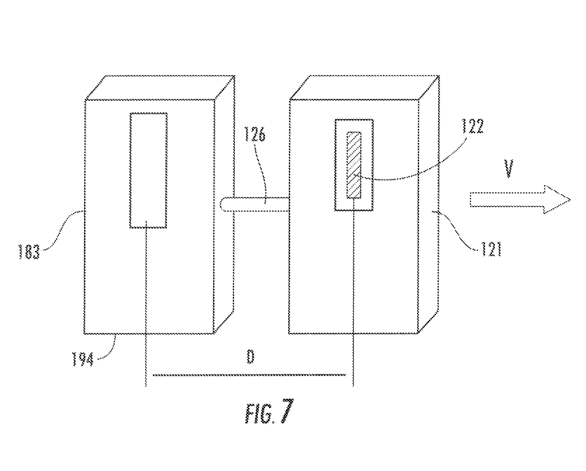

Referring now to FIGS. 6-8, a printing apparatus such as an ink jet printer 100 which may be used in accordance with an exemplary embodiment of the present invention is shown. As shown in FIG. 6, the ink jet printer 100 might comprise a printing device such as one including a print head 121 located about a print zone 125 such as within a printer housing 130. The print head 121 includes an ejector chip 122 comprising actuators associated with a plurality of discharge nozzles (not shown). An ink supply such as an ink filled container is in fluid communication with the ejector chip (in the illustrated embodiment the ink supply is integrally formed with the print head 121). The print head 121 is supported in a carrier 123 which, in turn, is supported on a guide rail 126 of the printer housing 130. A drive mechanism such as a drive belt 128 is provided for effecting reciprocating movement of the carrier 123 and the print head 121 back and forth along the guide rail 126. As the print head 121 moves back and forth, it ejects ink droplets via the ejector chip 122 onto a substrate 112 that is provided below it along a substrate feed path 136, to form a swath of information (typically having a width equal to the length of a column of discharges nozzles). As used throughout this description, the term “ink” is intended to include any aqueous or nonaqueous-based fluid, formulation or other substance suitable for forming a pattern on a substrate when deposited thereon.

A driver circuit 124 can provide voltage pulses to the actuators such as resistive heating elements or piezoelectric elements (not shown) located in the ejector chip 122. In the case of resistive heating elements, each voltage pulse is applied to one of the heater elements to momentarily vaporize ink in contact with that heating element to form a bubble within a bubble chamber (not shown) in which the heating element is located. The function of the bubble is to displace ink within the bubble chamber such that a droplet of ink is expelled from at least one of the discharge nozzles associated with the bubble chamber.

The printer housing 130 might include a tray 132 for storing substrates 112 to be printed upon. A rotatable feed roller 140 might be mounted within the housing 130 and positioned over the fray 132. Upon being rotated by a conventional drive device (not shown), the roller 140 grips the uppermost substrate 112 and feeds it along an initial portion of the substrate feed path 136. The feed path 136 portion is defined in substantial part by a pair of substrate guides 150. A coating apparatus 160 may optionally be used to apply a layer of coating material onto at least a portion of a first side of the substrate 112 prior to printing so as to facilitate better print quality.

A pair of first feed rollers 171 and 172 might be positioned within the housing 130 between the optional coating apparatus 160 and the print head 121. They are incrementally driven by a conventional roller drive device 174 that can also be controlled by the driver circuit 124. The first feed rollers 171 and 172 incrementally feed the substrate 112 into the print zone 125 and beneath the print bead 121. As noted above, the print head 121 ejects ink droplets 114 onto the substrate 112 as it moves back and forth along the guide rail 126 such that an image is printed on the substrate 112.

A pair of second feed rollers 210 and 212 can be positioned within housing 130 downstream from the print head 121. They are incrementally driven by a conventional roller drive device (not shown) that can be controlled by the driver circuit 124. The feed rollers 210 and 212 cause the printed substrate 112 to move through final substrate guides 214 and 216 to an output tray 134.

It will be understood by those skilled in the art that in other alternative exemplary embodiments, the housing 130 may include a flat bed tray (not shown), as opposed to the roller system described above, operable for accommodating rigid media, such as FR4 circuits boards. This flat bed tray might be mated with the housing 130 such that it moves forward and backward in an x and y direction thus providing the capability of printing on the rigid media.

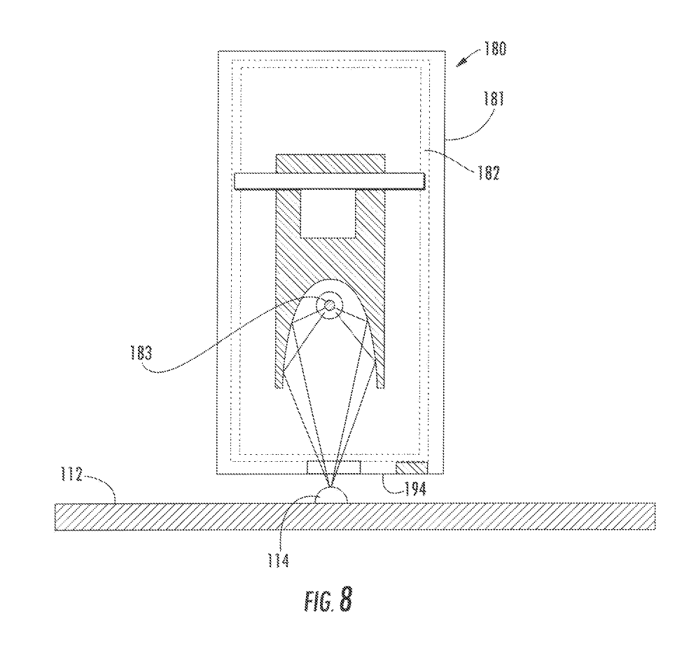

To fix the ink droplets to the substrate 112, moisture should be driven from the ink and the substrate 112. While it is possible to dry the ink by evaporation, evaporation has proven to require excessive time and to be inefficient. Accordingly, as shown in FIG. 7, positioned alongside the print head 121 can be a drying device 180 (also referred to herein as a “dryer”) in the form of, for example, a drying head 194 capable of generating heat energy for heating and drying the ink droplets 114 deposited on the substrate 112 by the print head 121. The drying head 194 might be supported in the earner 123, which in turn is supported on the guide rail 126 of the printer housing 130. The drying head 194 can be configured such that it moves at the same moving speed as a print head 121. In exemplary embodiments (FIG. 8), the drying head 194 includes an enclosure 181 having a geometry and size similar to that of the print head 121 and which can be latched and loaded in a manner similar to the print head 121 and installed on carrier 123 by a latching mechanism (not shown). It will be understood by those skilled in the art that the enclosure 181 can be constructed from a high temperature thermosetting plastic such as phenolic or polyimide with a reflective coating inside 182. The enclosure 181 can also be made from a high temperature thermosetting such as phenolic or polyimide, or high temperature resistance thermoplastics such as polyethylene terephthalate (PET), polyester ketone (PEEK), Liquid crystal polymer (LCP), or any reinforced plastics. The reflective coating 182, or lining, is provided on the interior walls of the enclosure 181, whereby the reflective coating 182 is operable for preventing leakage of radiation.

Disposed within the enclosure is a radiant emitter 183. The radiant emitter 183 may be any conventional emitter that is, for example, operable to transfer energy to water molecules of the ejected ink droplets 114, thereby causing evaporation of the droplet's water molecules and facilitating a rapid drying, on the order of seconds and potentially sub-second. In an exemplary embodiment, the emitter 183 is an infrared emitter. For example, the emitter 183 can be a short-wave infrared emitter. However, it will be understood by those skilled in the art that the emitter may be any emitter capable of transferring energy, including but not limited to, laser, visible incandescent filament or halogen type bulbs, ultra-violet, microwave, E-beam, or radio frequency emitters. The use of the infrared emitter 183 provides for a wider absorption bandwidth which can accommodate more types of printed substrates 112 for ink drying. Further, the use of an infrared emitter is currently more cost effective than other conventional electromagnetic wave emitters.

The selection of an infrared emitter (i.e., short-wave, medium-wave or long-wave) is dependent upon the characteristics of the ink compositions (generally water-based solutions) used and the substrate 112 to which the ink formulation is applied. Various types of infrared emitters having distinct wavelength emissions to accommodate various characteristics of inks and substrates 112. By way of example, a short wavelength infrared emitter can be used to provide high radiant efficiency and a fast rate of response. By using this type of emitter, water absorption is low. Therefore, relatively high power could be used for substantially instantaneous water drying. Short wavelength infrared radiation typically has greater surface penetration and, therefore if the substrate 112 is sensitive to the infrared radiation an alternative may be required. Medium and long wavelength emitters operate at lower radiant efficiencies (more heat energy goes to convective beating) and have slower response times. However, water tends to absorb much of the radiation in this spectrum. Accordingly, medium and long wavelength infrared emissions are absorbed less by the substrate and provides for better surface heating. Thus, when the substrate 112 is sensitive to infrared radiation, these emitters may be desirable.

Utilizing the foregoing exemplary printing system in accordance with the described printing process, it is possible to envision many different orders of operation where adjacent lines from one subset are printed and cured and then the second subset lines are printed in between these lines and cured. One could for example print lines of the critical width in a one line on, one line off configuration as the print head moves from left to right where the on carrier heater follows the print head and cures these lines and then print the complementary set of lines in the spaces between these lines as the print head moves from right to left. This can be accomplished in the printer driver software and would make it unnecessary for a user to actually subdivide their layout into subset geometries in a layout or CAD program.

### EXAMPLE 1

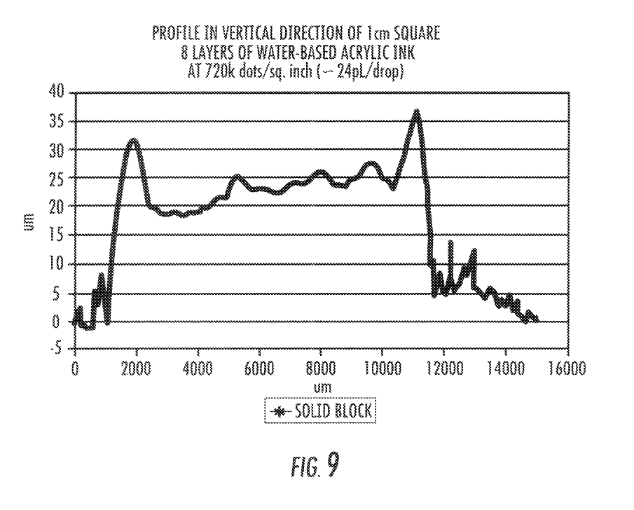

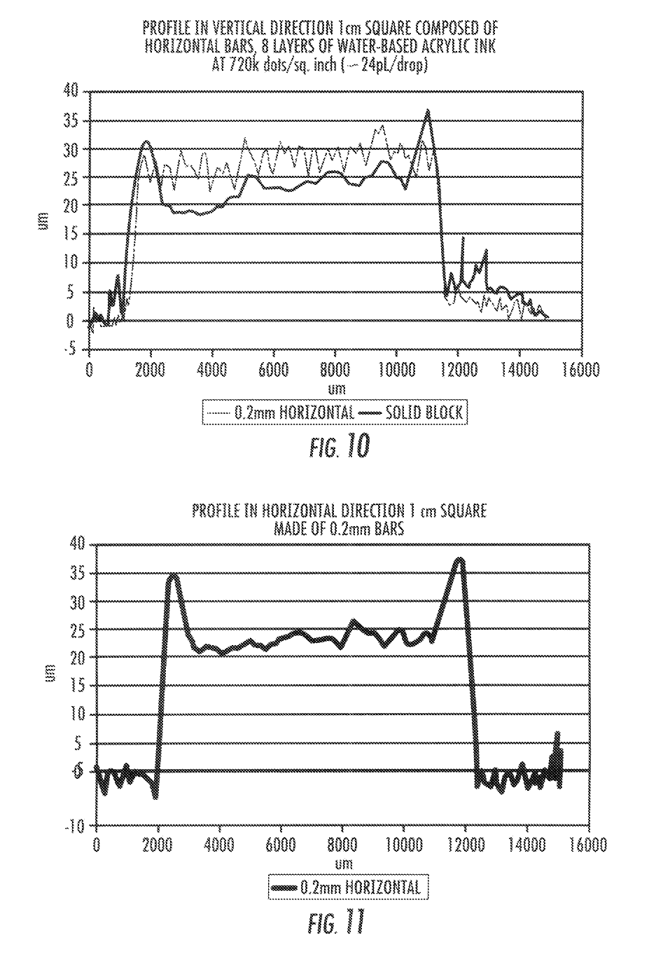

For the purpose of further illustrating the present invention, an acrylate based dielectric ink formulation has been used with an ink jet printer. As illustrated in the graph of FIG. 9, a 1 cm square image was printed in 8 solid overlapping layers separated by a 1 minute cure time under a heat lamp. The results set forth in FIG. 9 show a very pronounced coffee ring peak at the leading and trailing edges of the shape. By separating the 1 cm square into two subsets comprising 25 parallel 0.2 mm lines and printing each of these 2 “half layers” 8 times with a 1 minute heat lamp curing step between printing passes, a profile without high peaks at the edge of the printed shape and a rough, although generally level surface without the large dip in the middle, is produced. Significantly, both printings were made on the same printer with the same settings to achieve the same total volume of ink in the 1 cm square (720,000 drops per square inch). Referring now to FIG. 10, a graph of the cross section in the vertical, direction (across the component lines in the 0.2 mm direction) of the composite 1 cm square overlaid on the cross section of the original square from FIG. 9 is shown. A cross section of the composite square in the horizontal direction (in the same direction as the 1 cm length of the component vertical elements) shows some “coffee ring” peaks present at the top and bottom of the square as shown in FIG. 11.

In order to address this result, the square was broken into parallel vertical lines and then into parallel horizontal lines. Thereafter, the subsets were alternately printed (i.e., printing every other 2 part composite layer in the horizontal and vertical directions) so as to minimize the production of any coffee ring effect in both the horizontal and vertical directions. The results are shown in FIG. 12. Another manner of addressing this problem would be to subdivide the original square image into other geometrical subsets. By way of example, a checkerboard type arrangement may be employed. By way of another example, and as addressed above, an on-carrier/in printer heating/drying device could be used. Such a device may be used to allow the printing and curing architecture to be handled in software without requiring the user to physically remove the substrate between layers for curing. Advantageously, by using such a device, the total amount of material needed, and hence the required number of composite layers, may be reduced because more of the material ends up where it is needed.

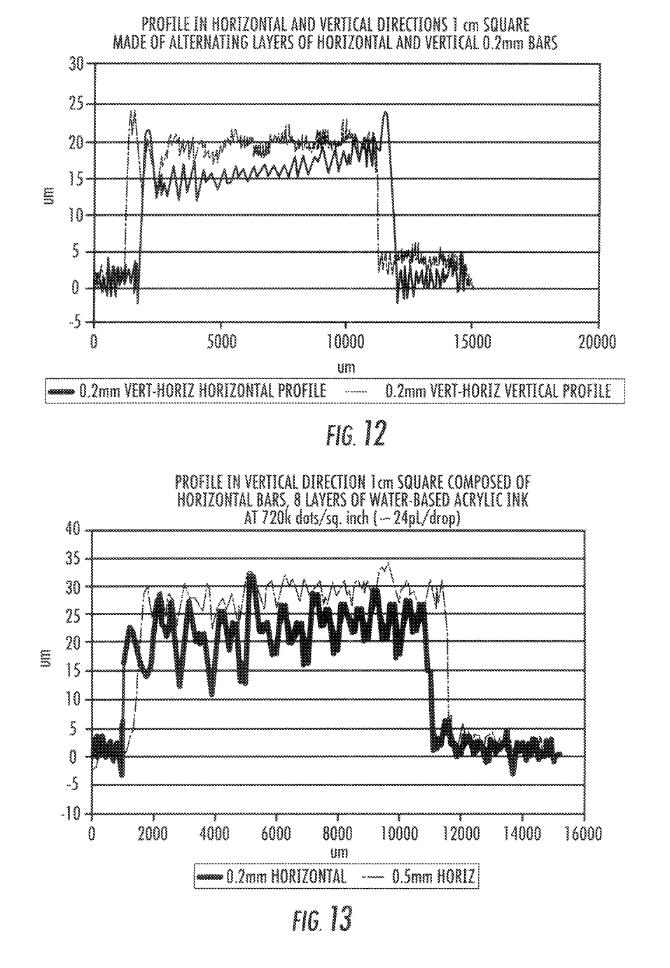

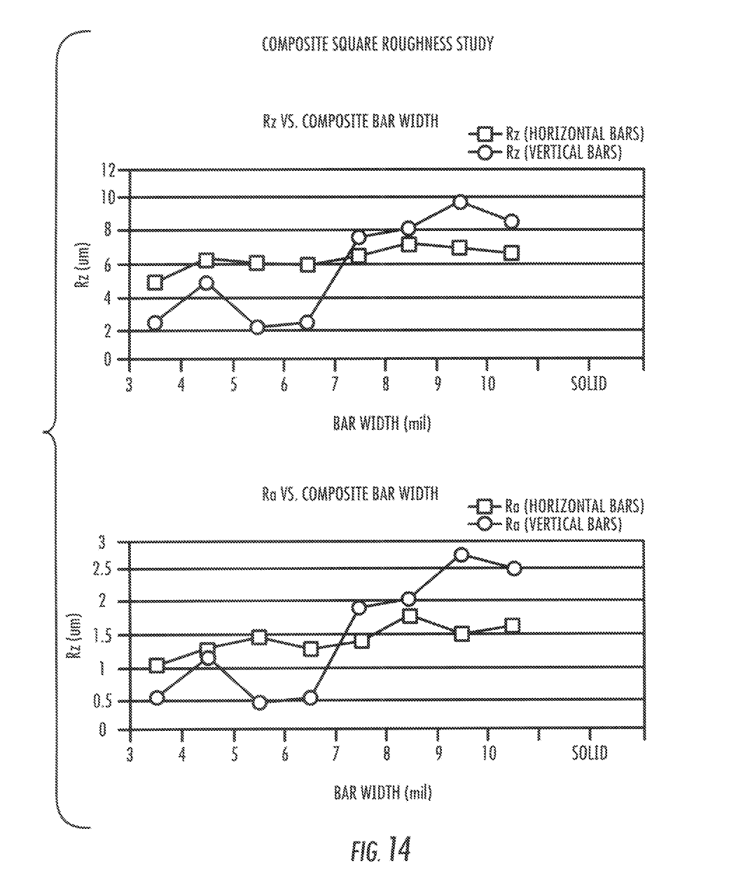

By using the exemplary printing method and process, it is also possible to tune the roughness of the surface by varying the line width of the geometric elements below the critical width for coffee ring formation, it has been found that narrower lines (geometric elements) result in finer frequency of peaks and valleys in the resulting surface profile with lower peaks and shallower valleys. This finding is illustrated in the graph of FIG. 13 where a 1 cm square composed of subsets comprising parallel 0.5 mm lines and 0.2 mm lines was used. At a certain point, however, a minimum width and separation may be reached below which theology and/or minimum achievable drop sizes dictate that adjacent lines spread and flow together, thereby presenting a practical limit to how fine the subdivision of the original pattern can be.

It will be appreciated by those skilled in the art that surface roughness can be advantageous for the promotion of adhesion to subsequently overprinted layers. By varying the width of printed subset elements, an optimal balance of surface profile, roughness, and adhesion may be achieved. This concept of tunable roughness is demonstrated for the narrow range of bar widths of 1 mil to 10 mils in FIG. 14. As shown in FIG. 14, a trend exists toward, higher Ra and Rz values as element bar width increases in a 1 cm composite square. In order to reduce roughness, each composite layer may be broken into geometrical elements as described above. Thereafter, geometric elements which comprise at least half of the composite layer are randomly selected and printed. Finally, the remaining elements (the complementary half) are printed. Repeating this randomization process with each subsequent composite layer adds randomness to the deposition and might reduce the regular periodicity observed in the roughness profile.

One advantage of the exemplary embodiment is evident when printing inks with a high surface tension onto smooth low energy surfaces. Typically, these conditions lead to a beading of fluid when it is printed onto the surface. Rather than holding the printed geometry the ink de-wets the surface and beads up, resulting in a highly non-uniform solids deposition once dried/cured. In the past, this has been addressed by the application of a surfactant pretreatment to the surface before printing the ink, or by the addition of surfactant to the ink formulation. By employing the methods and processes disclosed herein, the material is not permitted to bead up, as only continuous contacting regions can form beads. Thus, the need for a surface treatment or surfactant additive and result, in a more uniform wetting of the substrate is eliminated. Further, once an initial layer has been deposited in accordance with the exemplary embodiment, it may not be necessary for all subsequent layers to be subdivided into subset geometries to overcome beading/dewetting.

While the foregoing discussion has been directed to an inkjettable dielectric layer for use in a multi-layer printed circuit, it will be appreciated by those skilled in the art that the present invention is by no means limited to this application and the same can be extended to any number of printing applications or materials, such as those where it is desirable to have a uniform deposition of solids in the final film or layer and/or a controlled surface roughness for adhesion of subsequently overprinted layers. Further, it will be apparent to those skilled in the art that various modifications and variations can be made to the present invention without departing from the spirit and scope of the invention. Thus, it is intended that the present invention cover all conceivable modifications and variations of this invention, provided those alternative embodiments come within the scope of the appended claims and their equivalents.

What is claimed is:

1. A method of printing a pattern comprising:
subdividing the pattern into at least two subsets of geometrical elements; and
sequentially printing a fluid formulation upon a substrate in the form of the subsets of geometric elements so as to form a composite of the pattern,
wherein each subset of geometric elements is printed and dried prior to the printing of the remaining subsets of geometric elements.

2. The method of claim 1, wherein the composite pattern exhibits a more uniform distribution of material than the pattern would have had if it was not so subdivided.

3. The method of claim 1, wherein the composite pattern exhibits a desired roughness profile to promote adhesion of subsequently overprinted subsets.

4. The method of claim 1, wherein at least one of de-wetting and beading of the fluid formulation on the substrate is prevented.

5. The method of claim 1, wherein the subdividing of the pattern into the subsets of geometric elements is performed using a printer driver of a printing apparatus.

6. The method of claim 1, wherein the subsets of geometric elements are dried by an on-carrier heating device housed within a printing apparatus.

7. The method of claim 1, wherein, the subsets of geometric elements are a series of parallel bars separated by spaces.

8. The method of claim 1, wherein the subsets of geometric elements are comprised of shapes selected from the group consisting of squares, triangles, rectangles, hexagons, polygons and pentagons.

9. The method of claim 8, wherein shapes of the subsets of geometric are configured such that they can be at least one of interlocked and tessellated.

10. The method of claim 1, wherein the composite pattern is formed by randomly selecting half of the geometric elements, printing and drying the selected geometric elements, and then printing and drying the remaining, complimentary geometric elements to make the entire composite pattern.

11. The method of claim 1, wherein the printed pattern is at least one of a dielectric and an ink receiving layer in a multilevel printed circuit.

12. The method of claim 1, wherein the geometric elements are sized such that none are larger than a size at which a non-uniform deposition of materials onsets due to undesirable fluid flow.

13. The method of claim 1, wherein the geometric elements are macroscopic.

14. The method of claim 1, wherein the at least two subsets of geometric elements are such that they can be at least one of interlocked and tessellated.

15. A printing system comprising a means for subdividing a desired printed pattern into subsets having geometric elements, means for sequentially depositing fluid upon a substrate in the form of the subsets and a means for drying the fluid, wherein the means for drying the fluid emits energy, thereby drying the fluid prior to the deposition of the remaining subsets.

16. The printing system of claim 15, wherein the means for depositing the fluid comprises a housing having a guide rail for supporting a carrier and a printing apparatus supported in the carrier including a printing device capable of ejecting fluid droplets onto the substrate.

17. The printing system of claim 16, wherein the means for drying the fluid includes a drying device capable of emitting energy toward the ejected fluid droplets, the drying device being supported in the carrier and alongside the printing device.

18. The printing system of claim 17, wherein the drying emits energy at a fixed, time after the deposition of the fluid by the printing device.

19. The printing system of claim 17, wherein the energy emitted from the drying device is selected from the group consisting of infrared radiation, thermal energy, ultra-violet radiation, microwave radiation, radio frequency waves and electron-beam waves.

20. The printing system of claim 17, wherein the drying device and printing device move in conjunction with each other in a reciprocating manner along the guide rail at an adjustable moving speed.

21. A method of printing comprising subdividing a desired printed pattern into geometric elements; sequentially printing upon, a substrate the geometric elements in the form of subsets; and rapidly exposing the printed geometric elements to thermal energy to cure the geometric elements on the substrate prior to the deposition of the remaining geometric elements, wherein the composite shape of the printed geometric elements is the desired printed pattern.

22. The method of claim 21, further comprising preheating the substrate prior to printing the geometric elements to remove excess moisture from the substrate.

23. The method of claim 21, wherein exposing includes applying thermal energy by an on-carrier dryer comprising an enclosure; a radiant emitter; a reflector for focusing emissions from the radiant emitter toward the substrate; an electric circuit operable for controlling the power intensity and operation of the radiant emitter; and an exhaust for removing water vapors from the enclosure.
